(19) United States
(12) Patent Application Publication
(10) Pub. No.: US 2009/0220796 A1
(43) Pub. Date: Sep. 3, 2009

(54) Electro-conductive polymer composition and electrode material

(75) Inventors: Takashi Kato, Ashigarakami-gun (JP); Katsuyuki Yofu, Ashigarakami-gun (JP)

Correspondence Address: Moss & Burke, PLLC, 401 Holland Lane, Suite 407, Alexandria, VA, 22314, US

(73) Assignee: FUJIFILM CORPORATION, Tokyo (JP)

(21) Appl. No.: 12/379,325

(22) Filed: Feb. 19, 2009

(30) Foreign Application Priority Data
Feb. 29, 2008 (JP) 2008-051323

(51) Int. Cl. H01B 1/12; B32B 27/00

(52) U.S. Cl. 428/419; 252/500

(57) ABSTRACT

The electro-conductive polymer composition of the present invention contains an electro-conductive polymer and a compound represented by the following Formula (1). In Formula (1), R¹ represents a hydrogen atom, an alkyl group, an acyl group, an aryl group, an alkoxy group, an aryloxy group or a heteroaryl group. R² represents a hydrogen atom, an alkyl group, an aryl group, a heteroaryl group or a sulfonyl group.

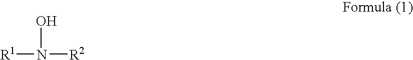

### CROSS REFERENCE TO RELATED APPLICATIONS

This application claims priority under 35USC 119 from Japanese Patent Application No. 2008-051323, the disclosure of which is incorporated herein by reference.

### BACKGROUND OF THE INVENTION

1. Field of the Invention

The present invention relates to an electro-conductive polymer composition and an electrode material.

2. Description of the Related Art

In recent years, displays typified by liquid crystal displays (LCD), plasma display panels (PDP), electroluminescence (EL) devices, or the like have increasingly been used widely in various fields such as television sets, computers and various types of mobile instruments which have recently been spreading increasingly, and are undergoing remarkable development. On the other hand, solar batteries are attracting attention as one of the non-fossil energies which pay consideration to the global environment. In order to address the need for further spread of solar batteries, research for improving the functions thereof and the like has been demanded. In such display devices and solar batteries, electro-conductive films are used.

Generally, electro-conductive films using metallic materials, such as ITO-based electro-conductive films, are produced by forming, on a glass substrate, a film from a metallic material by a vapor phase method such as a vacuum deposition method or a sputtering method. Display devices of cellular phones and mobile instruments have been becoming lighter in weight, and it has been demanded that display device substrates be shifted from glass to plastic. The introduction of plastic substrates has reduced the weight of display devices to half or less in comparison to conventional products, and the strength and the impact resistance have been increased remarkably.

There, however, is a problem with ITO-based electro-conductive films in that the substitution of glass substrates with plastic films results in a decrease in adhesiveness, making a substrate and a formed electro-conductive film prone to separate from each other. Moreover, metallic materials, such as ITO, require the use of an expensive production apparatus because they are formed into a film by using a vapor phase method such as sputtering.

Electro-conductive polymers are known as an electro-conductive material which substitutes for such conventional materials. The use of an electro-conductive polymer makes it possible to form a thin film which exhibits develop electric conductivity by coating, resulting in an advantage that such a film may be produced at low cost. Moreover, an electrode made of an electro-conductive polymer is more flexible and less brittle than ITO electrodes, and it therefore is less prone to break even if it is used in flexible items. For this reason, it also has an advantage that it may extend the life of devices if an electrode made of an electro-conductive polymer is used in a touch screen, which requires a particularly highly flexible electrode.

As such an electro-conductive polymer, a polythiophene containing a polyanion has been developed, and a technique of forming a thin film by using this polymer is disclosed in the specification of European Patent No. 440957. It, however, has become clear that this electro-conductive film is slightly weaker in durability than ITO films and the like and that it may not achieve a durability sufficient for practical use in some applications. Particularly, in the event that an electro-conductive film is used for display devices or the like, what is important is the photo-durability, that is, the property that neither the transparency nor the electrical conductivity of the film decreases even after irradiation with light of at least a certain intensity.

On the other hand, an electro-conductive film in which polyphosphoric acid and a specified phenolic compound have been added to polythiophene has been proposed in Japanese Patent Application Laid-Open (JP-A) No. 2006-505099. This document discloses that the addition of polyphosphoric acid, or the like increases the photo-durability, that is, the increase in surface resistivity upon exposure to light is inhibited.

### SUMMARY OF THE INVENTION

A first aspect of the present invention is an electro-conductive polymer composition containing an electro-conductive polymer and a compound represented by the following Formula (1):

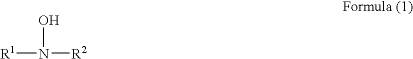

wherein in Formula (1), R¹ represents a hydrogen atom, an alkyl group, an acyl group, an aryl group, an alkoxy group, an aryloxy group or a heteroaryl group; and R² represents a hydrogen atom, an alkyl group, an aryl group, a heteroaryl group or a sulfonyl group.

A second aspect of the present invention is an electrode material having, on a support, a layer formed by applying the electro-conductive polymer composition of the first aspect.

### DETAILED DESCRIPTION OF THE INVENTION

Although the photo-durability is certainly increased by the technique of JP-A 2006-505099, it has become clear that if an electro-conductive polymer, such as polythiophene, is mixed with polyphosphoric acid, the electro-conductive polymer aggregates in some cases, resulting in difficulty in obtaining a uniform electro-conductive film. It has been found that this aggregation also leads to a decrease in transparency of the film and also to a increase in surface resistivity of the film immediately after the formation thereof.

In light of such circumstances, it was found, through extensive research by the present inventors, that in a composition in which a compound represented by Formula (1) shown below had been added to an electro-conductive polymer, no aggregation of the electro-conductive polymer occurred and, as a result, the composition was able to form an electro-conductive film excellent in transparency and electrical conductivity, and that the electro-conductive film is excellent in photo-durability. After more research based on these findings, the present invention was accomplished. It should be noted that, in the present invention, “photo-durability” means the changes in transparency and surface resistivity after exposure to outdoor light or to a light source such as a xenon lamp light source for a certain period of time. The smaller the changes in the transparency and the surface resistivity are, the better the photo-durability is.

According to the present invention, it is possible to provide an electro-conductive polymer composition in which no coagulation of an electro-conductive polymer will occur and from which an electro-conductive film excellent in photo-durability, transmittance and electrical conductivity may be formed, and it is also possible to provide an electrode material excellent in photo-durability, transmittance and electrical conductivity.

The present invention will be described in detail below. In the present specification “ . . . to . . . ” represents a range including the numeral values represented before and after “to” as a minimum value and a maximum value, respectively.

### <Electro-Conductive Polymer Composition>

The electro-conductive polymer composition of the present invention contains, at least, (1) an electro-conductive polymer and (2) a compound represented by the following Formula (1).

### (1) Electro-Conductive Polymer

The electro-conductive polymer to be used for the present invention refers to a polymer which exhibits an electrical conductivity of 10⁻⁶ S·cm⁻¹ or more. Any polymer corresponding to the above may be used. More preferred is a polymer having an electrical conductivity of 10⁻¹ S·cm⁻¹ or more.

The electro-conductive polymer is preferably a non-conjugated polymer or conjugated polymer made up of aromatic carbon rings or aromatic heterocycles linked by single bonds or divalent or multivalent linking groups.

The aromatic carbon rings in the non-conjugated polymer or conjugated polymer is, for example, a benzene ring and also may be formed a fused ring.

The aromatic heterocycle in the non-conjugated polymer or conjugated polymer is, for example, a pyridine ring, a pyrazine ring, a pyrimidine ring, a pyridazine ring, a triazine ring, an oxazole ring, a thiazole ring, an imidazole ring, an oxadiazole ring, a thiadiazole ring, a triazole ring, a tetrazole ring, a furan ring, a thiophene ring, a pyrrole ring, an indole ring, a carbazole ring, a benzimidazole ring, an imidazopyridine ring, or the like. It also may be formed a fused ring and may have a substituent.

Examples of the divalent or multivalent linking group in a non-conjugated polymer or conjugated polymer include linking groups formed by a carbon atom, a silicon atom, a nitrogen atom, a boron atom, an oxygen atom, a sulfur atom, metal, metal ion, or the like. Preferred are a carbon atom, a nitrogen atom, a silicon atom, a boron atom, an oxygen atom, a sulfur atom, and a group formed of a combination thereof. Examples of such a group formed of a combination include a methylene group, a carbonyl group, an imino group, a sulfonyl group, a sulfinyl group, an ester group, an amide group and a silyl group, which are either substituted or unsubstituted.

Specific examples of the electro-conductive polymer include polyaniline, poly(paraphenylene), poly(paraphenylenevinylene), polythiophene, polyfuran, polypyrrole, polyselenophene, polyisothianaphthene, polyphenylene sulfide, polyacethylene, polypyridylvinylene and polyazine, which are electro-conductive and are either substituted or non-substituted. These may be used either singly or, according to the purpose, in combination of two or more kinds thereof.

If a desired electrical conductivity is achieved, it may be used in the form of a mixture with another polymer having no electrical conductivity, and copolymers of such monomers with other monomers having no electrical conductivity may also be used.

The electro-conductive polymer is preferably a conjugated polymer. Examples of such a conjugated polymer include polyacethylene, polydiacetylene, poly(paraphenylene), polyfluorene, polyazulene, poly(paraphenylene sulfide) polypyrrole, polythiophene, polyisothianaphthene, polyaniline, poly(paraphenylenevinylene), poly(2,5-thienylenevinylene), multiple chain type conjugated polymers (polyperinaphthalene, an the like), metal phthalocyanine-type polymers, and other conjugated polymers [poly(paraxylylene), poly[α-(5,5′-bithiophenediyl)benzylidene], and the like).

Preferred are poly(paraphenylene), polypyrrole, polythiophene, polyaniline, poly(paraphenylenevinylene) and poly(2,5-thienylenevinylene). More preferred are poly(paraphenylene), polythiophene and poly(paraphenylenevinylene).

Such conjugated polymers may have a substituent, examples of the substituent include substituents which are described as R¹¹ in Formula (I) given below.

In the present invention, it is preferable, from the viewpoint of compatibility of high transparency and high electrical conductivity, particularly that the electro-conductive polymer have a partial structure represented by the following Formula (I) (in other words, that it be polythiophene or its derivative).

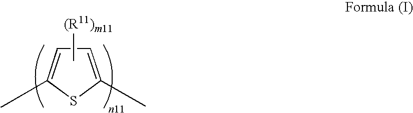

In Formula (I), R¹¹ represents a substituent; and m11 represents an integer of from 0 to 2. When m11 represents 2, the R¹¹s may be either the same or different and also may be linked each other to form a ring. n¹¹ represents an integer of 1 or greater.

The substituent represented by R¹¹ includes alkyl groups (preferably having 1 to 20 carbon atoms, more preferably having 1 to 12 carbon atoms, and still more preferably having 1 to 8 carbon atoms; for example, methyl, ethyl, isopropyl, tert-butyl, n-octyl, n-decyl, n-hexadecyl, cyclopropyl, cyclopentyl and, cyclohexyl), alkenyl groups (preferably having 2 to 20 carbon atoms, more preferably having 2 to 12 carbon atoms, and still more preferably having 2 to 8 carbon atoms; for example, vinyl, allyl, 2-butenyl, 3-pentenyl, 2-hexenyl, 3-hexenyl, 4-hexenyl and 2-octenyl), alkynyl groups (preferably having 2 to 20 carbon atoms, more preferably having 2 to 12 carbon atoms, and still more preferably having 2 to 8 carbon atoms; for example, propargyl and 3-pentynyl), aryl groups (preferably having 6 to 30 carbon atoms, more preferably having 6 to 20 carbon atoms, and still more preferably having 6 to 12 carbon atoms; for example, phenyl, p-methylphenyl and naphthyl), amino group (preferably having 0 to 20 carbon atoms, more preferably having 0 to 10 carbon atoms, and still more preferably having 0 to 6 carbon atoms; for example, amino, methylamino, dimethylamino, diethylamino, dibenzylamino, and diphenylamino),

alkoxy groups (preferably having 1 to 20 carbon atoms, more preferably having 1 to 12 carbon atoms, and still more preferably having 1 to 8 carbon atoms; for example, methoxy, ethoxy, butoxy, hexyloxy and octyloxy), aryloxy groups (preferably having 6 to 20 carbon atoms, more preferably having 6 to 16 carbon atoms, and still more preferably having 6 to 12 carbon atoms; for example, phenyloxy and 2-naphthyloxy), acyl groups (preferably having 1 to 20 carbon atoms, more preferably having 1 to 16 carbon atoms, and still more preferably having 1 to 12 carbon atoms; for example, acetyl, benzoyl, formyl and pivaloyl), alkoxycarbonyl groups (preferably having 2 to 20 carbon atoms, more preferably having 2 to 16 carbon atoms, and still more preferably having 2 to 12 carbon atoms; for example, methoxycarbonyl and ethoxycarbonyl), aryloxycarbonyl groups (preferably having 7 to 20 carbon atoms, more preferably having 7 to 16 carbon atoms, and still more preferably having 7 to 10 carbon atoms; for example, phenyloxycarbonyl),

acyloxy group (preferably having 2 to 20 carbon atoms, more preferably having 2 to 16 carbon atoms, and still more preferably having 2 to 10 carbon atoms; for example, acetoxy and benzoyloxy), acylamino groups (preferably having 2 to 20 carbon atoms, more preferably having 2 to 16 carbon atoms, and still more preferably having 2 to 10 carbon atoms; for example, acetylamino and benzoylamino), alkoxycarbonylamino groups (preferably having 2 to 20 carbon atoms, more preferably having 2 to 16 carbon atoms, and still more preferably having 2 to 12 carbon atoms; for example, methoxycarbonylamino), aryloxycarbonylamino groups (preferably having 7 to 20 carbon atoms, more preferably having 7 to 16 carbon atoms, and still more preferably having 7 to 12 carbon atoms; for example, phenyloxycarbonylamino), sulfonylamino groups (preferably having 1 to 20 carbon atoms, more preferably having 1 to 16 carbon atoms, and still more preferably having 1 to 12 carbon atoms; for example, methanesulfonylamino and benzenesulfonylamino), a sulfamoyl group (preferably having 0 to 20 carbon atoms, more preferably having 0 to 16 carbon atoms, and still more preferably having 0 to 12 carbon atoms; for example, sulfamoyl, methylsulfamoyl, dimethylsulfamoyl and phenylsulfamoyl),

carbamoyl groups (preferably having 1 to 20 carbon atoms, more preferably having 1 to 16 carbon atoms, and still more preferably having 1 to 12 carbon atoms; for example, carbamoyl, methylcarbamoyl, diethylcarbamoyl and phenylcarbamoyl), alkylthio groups (preferably having 1 to 20 carbon atoms, more preferably having 1 to 16 carbon atoms, and still more preferably having 1 to 12 carbon atoms; for example, methylthio and ethylthio), arylthio groups (preferably having 6 to 20 carbon atoms, more preferably having 6 to 16 carbon atoms, and still more preferably having 6 to 12 carbon atoms; for example, phenylthio), sulfonyl groups (preferably having 1 to 20 carbon atoms, more preferably having 1 to 16 carbon atoms, and still more preferably having 1 to 12 carbon atoms; for example, mesyl and tosyl), sulfinyl groups (preferably having 1 to 20 carbon atoms, more preferably having 1 to 16 carbon atoms, and still more preferably having 1 to 12 carbon atoms; for example, methanesulfinyl and benzenesulfinyl), ureido groups (preferably having 1 to 20 carbon atoms, more preferably having 1 to 16 carbon atoms, and still more preferably having 1 to 12 carbon atoms; for example, ureido, methylureido and phenylureido), phosphoramide groups (preferably having 1 to 20 carbon atoms, more preferably having 1 to 16 carbon atoms, and still more preferably having 1 to 12 carbon atoms; for example, diethyl phosphoramide and phenyl phosphoramide),

a hydroxy group, a mercapto group, halogen atoms (for example, fluorine atom, chlorine atom, bromine atom and iodine atom), a cyano group, a sulfo group, a carboxyl group, a nitro group, a hydroxamic acid group, a sulfino group, a hydrazino group, an imino group, heterocyclic groups (preferably having 1 to 20 carbon atoms and more preferably having 1 to 12 carbon atoms; examples of hetero atoms include a nitrogen atom, an oxygen atom and a sulfur atom; specific examples include pyrrolidine, piperidine, piperazine, morpholine, thiophene, furan, pyrrole, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylydine, quinoxaline, quinazoline, cinnoline, pteridine, acridine, phenanthroline, phenazine, tetrazole, benzimidazole, benzoxazole, benzthiazole, benzotriazole and tetraazaindene), and silyl groups (preferably having 3 to 40 carbon atoms, more preferably having 3 to 30 carbon atoms, and still more preferably having 3 to 24 carbon atoms; for example, trimethylsilyl and triphenylsilyl).

The substituent represented by R¹¹ may be additionally substituted. When it has a plural substituents, they may be either the same or different and may, if possible, be linked together to form a ring. Examples of the ring to be formed include a cycloalkyl ring, a benzene ring, a thiophene ring, a dioxane ring and a dithiane ring.

The substituent represented by R¹¹ is preferably an alkyl group, an alkenyl group, an alkynyl group, an alkoxy group and an alkylthio group, and more preferably an alkyl group, an alkoxy group and an alkylthio group. In still more preferably, when m11 is 2, two R¹¹s are alkoxy groups or alkylthio groups forming a ring, and it is preferable to form a dioxane ring or a dithiane ring.

When m11 is 1 in Formula (I), R¹¹ is preferably an alkyl group, and more preferably an alkyl group having 2 to 8 carbon atoms.

When Formula (I) is poly(3-alkylthiophene) that R¹¹ is an alkyl group, the linkage mode between the adjacent thiophene rings includes a sterically regular mode in which all thiophene rings are linked by 2-5′ and a sterically irregular mode which contains 2-2′ linkages and 5-5′ linkages. Among them, the sterically irregular mode is preferred.

In the present invention, it is particularly preferable, from the viewpoint of achieving both high transparency and high electrical conductivity, that the electro-conductive polymer is 3,4-ethylenedioxy-polythiophene, which is specific example compound (6) shown below.

The polythiophene represented by Formula (I) and derivatives thereof may be prepared by known methods such as those disclosed in J. Mater. Chem., 15, 2077-2088 (2005) and Advanced Materials, 12(7), 481 (2000). For examples, Denatron P502 (manufactured by NAGASE CHEMICAL CO., LTD.), 3,4-ethylenedioxythiophene (BAYTRON (registered trademark) M V2), and 3,4-polyethylenedioxythiopene/polystyrenesulfonate (BAYTRON (registered trademark) P), BAYTRON (registered trademark) C), BAYTRON (registered trademark) F E, BAYTRON (registered trademark) M V2, BAYTRON (registered trademark) P, BAYTRON (registered trademark) P AG, BAYTRON (registered trademark) P HC V4, BAYTRON (registered trademark) P HS, BAYTRON (registered trademark) PH, BAYTRON (registered trademark) PH 500 and BAYTRON (registered trademark) PH 510 (all the BAYTRONs are manufactured by H.C. Starck GmbH) may be obtained as commercial products.

A polyaniline (manufactured by Aldrich Chemical Company, Inc.), a polyaniline (ereraldine (phonetic) base) (manufactured by Aldrich Chemical Company, Inc.), or the like are available as polyaniline and derivatives thereof.

A polypyrrole (manufactured by Aldrich Chemical Company, Inc.) or the like are available as polypyrrole and derivatives thereof.

Specific examples of an electro-conductive polymer are shown below, but the present invention is not limited to them. Besides these, compounds disclosed in WO98/01909 and so on are also provided as examples.

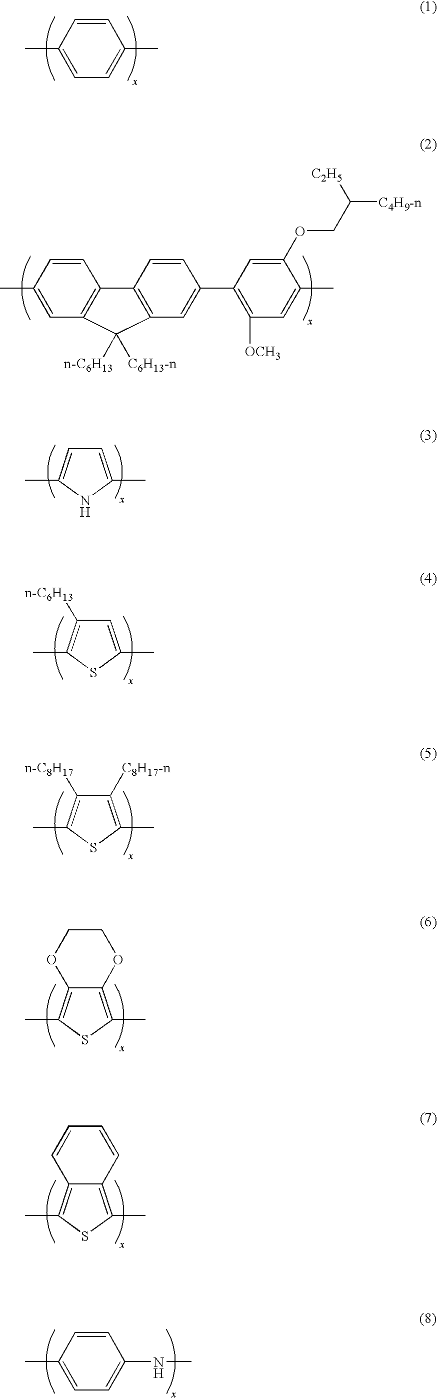

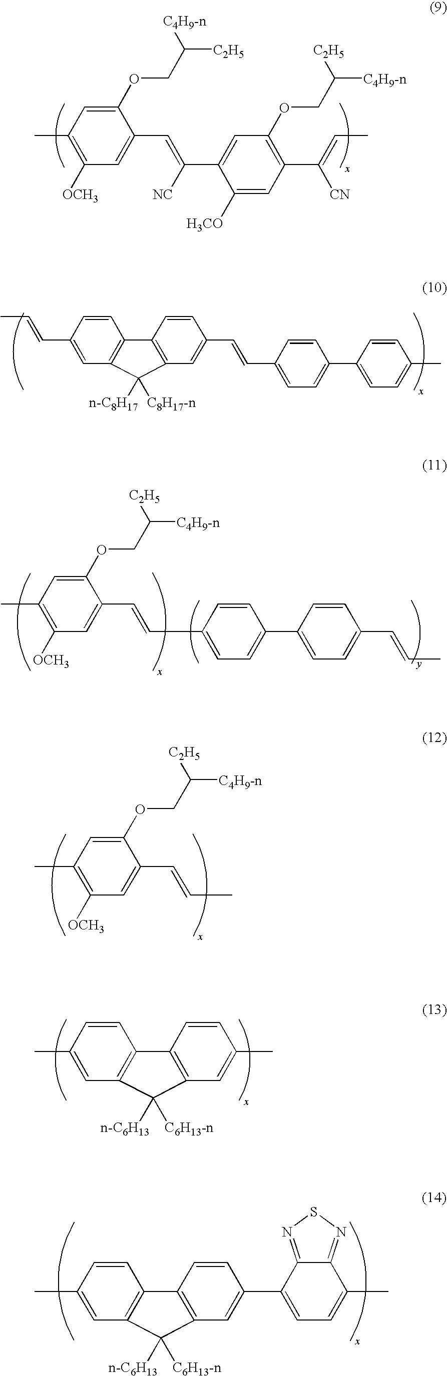

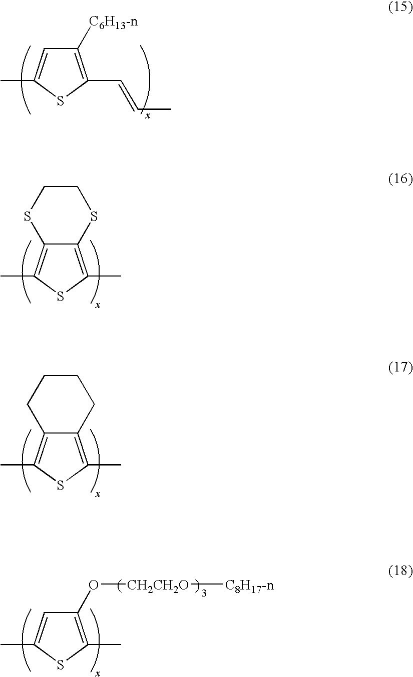

The weight average molecular weight of an electro-conductive polymer to be used in the present invention is preferably from 1,000 to 1,000,000, more preferably from 10,000 to 500,000, and still more preferably from 10,000 to 100,000.

### (2) Compound Represented by Formula (1)

The electro-conductive polymer composition of the present invention contains a compound represented by the following Formula (1). The compound represented by Formula (1) is hard to cause coagulation even if it is allowed to exist together with an electro-conductive polymer. Therefore, a film formed by using the electro-conductive composition of the present invention which contains the compound represented by Formula (1) and the above-mentioned electro-conductive polymer exhibits high transparency and high electrical conductivity and is also excellent in photo-durability.

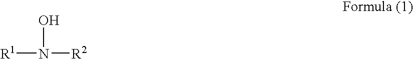

In Formula (1), R¹ represents a hydrogen atom, an alkyl group, an acyl group, an aryl group, an alkoxy group, an aryloxy group or a heteroaryl group. In Formula (1), R² represents a hydrogen atom, an alkyl group, an aryl group, a heteroaryl group or a sulfonyl group.

R¹ and R² in Formula (1) each may have a substituent. The substituents may be in the following substituent group V.

(Substituent Group V)

Halogen atom (for example, chlorine, bromine, iodine, fluorine); a mercapto group; a cyano group; a carboxyl group; a phosphoric acid group; a sulfo group; a hydroxy group; carbamoyl groups having 1 to 10 carbon atoms, preferably having 2 to 8 carbon atoms, and more preferably having 2 to 5 carbon atoms (for example, a methylcarbamoyl group, an ethylcarbamoyl group and a morpholinocarbamoyl group); sulfamoyl groups having 0 to 10 carbon atoms, preferably having 2 to 8 carbon atoms, and more preferably having 2 to 5 carbon atoms (for example, a methylsulfamoyl group, an ethylsulfamoyl group and a piperidinosulfamoyl group); a nitro group; alkoxy groups having 1 to 20 carbon atoms, preferably having 1 to 10 carbon atoms, and more preferably having 1 to 8 carbon atoms (for example, a methoxy group, an ethoxy group, a 2-methoxyethoxy group and a 2-phenylethoxy group); aryloxy groups having 6 to 20 carbon atoms, preferably having 6 to 12 carbon atoms, and more preferably having 6 to 10 carbon atoms (for example, a phenoxy group, a p-methylphenoxy group, a p-chlorophenoxy group and a naphthoxy group); acyl groups having 1 to 20 carbon atoms, preferably having 2 to 12 carbon atoms, and more preferably having 2 to 8 carbon atoms (for example, an acetyl group, a benzoyl and a trichloroacetyl group); acyloxy groups having 1 to 20 carbon atoms, preferably having 2 to 12 carbon atoms, and more preferably having 2 to 8 carbon atoms (for example, an acetyloxy group and a benzoyloxy group); acylamino groups having 1 to 20 carbon atoms, preferably having 2 to 12 carbon atoms, and more preferably having 2 to 8 carbon atoms (for example, an acetylamino group);

sulfonyl groups having 1 to 20 carbon atoms, preferably having 1 to 10 carbon atoms, and more preferably having 1 to 8 carbon atoms (for example, a methanesulfonyl group, an ethanesulfonyl group and a benzenesulfonyl group); sulfinyl groups having 1 to 20 carbon atoms, preferably having 1 to 10 carbon atoms, and more preferably having 1 to 8 carbon atoms (for example, a methanesulfinyl group, an ethanesulfinyl group and a benzenesulfinyl group); sulfonylamino groups having 1 to 20 carbon atoms, preferably having 1 to 10 carbon atoms, and more preferably having 1 to 8 carbon atoms (for example, a methanesulfonylamino group, an ethanesulfonylamino group and a benzenesulfonylamino group); substituted or unsubstituted amino groups having 0 to 20 carbon atoms, preferably having 0 to 12 carbon atoms, and more preferably having 0 to 8 carbon atoms (for example, an unsubstituted amino group, a methylamino group, a dimethylamino, a benzylamino group, an anilino group and a diphenylamino group); ammonium groups having 0 to 15 carbon atoms, preferably having 3 to 10 carbon atoms, and more preferably having 3 to 6 carbon atoms (for example, a trimethylammonium group and a triethylammonium group); hydrazino groups having 0 to 15 carbon atoms, preferably having 1 to 10 carbon atoms, and more preferably having 1 to 6 carbon atoms (for example, a trimethylhydrazino group); ureido groups having 1 to 15 carbon atoms, preferably having 1 to 10 carbon atoms, and more preferably having 1 to 6 carbon atoms (for example, an ureido group and an N,N-dimethylureido group); imide groups having 1 to 15 carbon atoms, preferably having 1 to 10 carbon atoms, and more preferably having 1 to 6 carbon atoms (for example, a succinimide group);

alkylthio groups having 1 to 20 carbon atoms, preferably having 1 to 12 carbon atoms, and more preferably having 1 to 8 carbon atoms (for example, a methylthio group, an ethylthio group and a propylthio group); arylthio groups having 6 to 80 carbon atoms, preferably having 6 to 40 carbon atoms, and more preferably having 6 to 30 carbon atoms (for example, a phenylthio group, a p-methylphenylthio group, a p-chlorophenylthio group, a 2-pyridylthio group, a 1-naphthylthio group, a 2-naphthylthio group, a 4-propylcyclohexyl-4′-biphenylthio group, a 4-butylcyclohexyl-4′-biphenylthio group, a 4-pentylcyclohexyl-4′-biphenylthio group and a 4-propylphenyl-2-ethynyl-4′-biphenylthio group); heteroarylthio groups having 1 to 80 carbon atoms, preferably having 1 to 40 carbon atoms, and more preferably having 1 to 30 carbon atoms (for example, a 2-pyridylthio group, a 3-pyridylthio group, a 4-pyridylthio group, a 2-quinolylthio group, 2-furylthio group and a 2-pyrrolylthio group); alkoxycarbonyl groups having 2 to 20 carbon atoms, preferably having 2 to 12 carbon atoms, and more preferably having 2 to 8 carbon atoms (for example, a methoxycarbonyl group, an ethoxycarbonyl group and a 2-benzyloxycarbonyl group), aryloxycarbonyl groups having 6 to 20 carbon atoms, preferably having 6 to 12 carbon atoms, and more preferably having 6 to 10 carbon atoms (for example, a phenoxycarbonyl group);

unsubstituted alkyl groups having 1 to 18 carbon atoms, preferably having 1 to 10 carbon atoms, and more preferably having 1 to 5 carbon atoms (for example, a methyl group, an ethyl group, a propyl group and a butyl group); substituted alkyl groups having 1 to 18 carbon atoms, preferably having 1 to 10 carbon atoms, and more preferably having 1 to 5 carbon atoms (for example, a hydroxymethyl, a trifluoromethyl group, a benzyl group, a carboxyethyl group, an ethoxycarbonylmethyl group and an acetylaminomethyl group, wherein unsaturated hydrocarbon groups having 2 to 18 carbon atoms, preferably having 3 to 10 carbon atoms, and more preferably having 3 to 5 carbon atoms (for example, a vinyl group, an ethynyl group, a 1-cyclohexenyl group, a benzylidyne group and a benzylidene group) shall be included in the substituted alkyl groups); substituted or unsubstituted aryl groups having 6 to 20 carbon atoms, preferably having 6 to 15 carbon atoms, and more preferably having 6 to 10 carbon atoms (for example, a phenyl group, a naphthyl group, a p-carboxyphenyl group, a p-nitrophenyl group, a 3,5-dichlorophenyl group, a p-cyanophenyl group, a m-fluorophenyl group, a p-tolyl group, 4-propylcyclohexyl-4′-biphenyl, 4-butylcyclohexyl-4′-biphenyl, 4-pentylcyclohexyl-4′-biphenyl and 4-propylphenyl-2-ethynyl-4′-biphenyl); and substituted or unsubstituted heterocyclic groups having 1 to 20 carbon atoms, preferably having 2 to 10 carbon atoms, and more preferably having 4 to 6 carbon atoms (for example, a pyridyl group, a 5-methylpyridyl group, a thienyl group, a furyl group, a morpholino group and a tetrahydrofurfuryl group) are included.

Substituents of the substituent group V may form a structure in which a benzene ring or a naphthalene ring is fused. Furthermore, such substituents may be additionally substituted. Such an additional substituent may be any one selected from the substituent group V.

The alkyl group represented by R¹ of Formula (1) is an alkyl group preferably having 1 to 60 carbon atoms, more preferably having 1 to 50 carbon atoms, and still more preferably having 1 to 40 carbon atoms. Specific examples are methyl, tert-butyl, tert-octyl, 2-ethylhexyl, cyclohexyl, n-hexadecyl, 3-dodecyloxypropyl and 3-(2′,4′-di-tert-pentylphenoxy)propyl.

The acyl group represented by R¹ of Formula (1) is an acyl group preferably having 1 to 60 carbon atoms, more preferably having 1 to 50 carbon atoms, and still more preferably having 1 to 40 carbon atoms. Specific examples include acetyl, benzoyl, trichloroacetyl, a phenylcarbonyl group and an ethylcarbonyl group.

The aryl group represented by R¹ of Formula (1) is an aryl group preferably having 6 to 60 carbon atoms, more preferably having 6 to 50 carbon atoms, and still more preferably having 6 to 40 carbon atoms. Specific examples include phenyl, 1-naphthyl, p-tolyl, o-tolyl, 4-methoxyphenyl, 4-hexadecyloxyphenyl, 3-pentadecylphenyl, 2,4-di-tert-pentylphenyl, 8-quinolyl and 5-(1-dodecyloxycarbonylethoxycarbonyl)-2-chlorophenyl.

The alkoxy group represented by R¹ of Formula (1) is an alkoxy group preferably having 1 to 60 carbon atoms, more preferably having 1 to 50 carbon atoms, and still more preferably having 1 to 40 carbon atoms. Specific examples include methoxy, ethoxy, butoxy, methoxyethoxy and n-octyloxy.

The aryloxy group represented by R¹ of Formula (1) is an aryloxy group preferably having 6 to 60 carbon atoms, more preferably having 6 to 50 carbon atoms, and still more preferably having 6 to 40 carbon atoms. Specific examples include phenoxy and 4-tert-octylphenoxy.

The heteroaryl group represented by R¹ of a Formula (1) is preferably a 5- to 8-membered heteroaryl group containing at least one heteroatom selected from among N, S, O and Se. Specific examples include 4-pyridyl, 2-furyl, 2-pyrrole, 2-thiazolyl, 3-thiazolyl, 2-oxazolyl, 2-imidazolyl, triazolyl, tetrazolyl, benzotriazolyl, 2-quinolyl and 3-quinolyl.

The alkyl group represented by R² of Formula (1) is an alkyl group preferably having 1 to 60 carbon atoms, more preferably having 1 to 50 carbon atoms, and still more preferably having 1 to 40 carbon atoms. Specific examples include methyl, tert-butyl, tert-octyl, 2-ethylhexyl, cyclohexyl, n-hexadecyl, 3-dodecyloxypropyl and 3-(2′,4′-di-tert-pentylphenoxy)propyl.

The aryl group represented by R² of Formula (1) is an aryl group preferably having 6 to 60 carbon atoms, more preferably having 6 to 50 carbon atoms, and still more preferably having 6 to 40 carbon atoms. Specific examples include phenyl, 1-naphthyl, p-tolyl, o-tolyl, 4-methoxyphenyl, 4-hexadecyloxyphenyl, 3-pentadecylphenyl, 2,4-di-tert-pentylphenyl, 8-quinolyl and 5-(1-dodecyloxycarbonylethoxycarbonyl)-2-chlorophenyl.

The heteroaryl group represented by R² of a Formula (1) is preferably a 5- to 8-membered heteroaryl group containing at least one heteroatom selected from among N, S, O and Se. Specific examples include 4-pyridyl, 2-furyl, 2-pyrrole, 2-thiazolyl, 3-thiazolyl, 2-oxazolyl, 2-imidazolyl, triazolyl, tetrazolyl, benzotriazolyl, morpholinyl, and the like.

The sulfonyl group represented by R² of Formula (1) is a sulfonyl group preferably having 1 to 60 carbon atoms, more preferably having 1 to 50 carbon atoms, and still more preferably having 1 to 40 carbon atoms. Specific examples include phenylslufonyl, methylsulfonyl, ethylsulfonyl and propylsulfonyl.

R¹ and R² may be either the same or different. Moreover, R¹ and R² may be linked together to form a ring.

A hydroxamic acid compound or a hydroxyamine compound is suitable as the compound represented by Formula (1) to be used for the present invention.

### —Hydroxamic Acid Compound—

A compound represented by the following Formula (2) is preferred as the hydroxamic acid compound.

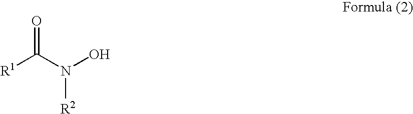

In Formula (2), R¹ is a hydrogen atom, an alkyl group, an aryl group, a heteroaryl group, an alkoxy group or an aryloxy group, is preferably an alkyl group or an aryl group, and more preferably an alkyl group or a phenyl group which may be substituted.

The alkyl group represented by R¹ of Formula (2) is preferably an alkyl group having 1 to 60 carbon atoms, more preferably an alkyl group having 1 to 50 carbon atoms, and still more preferably an alkyl group having 1 to 40 carbon atoms. The alkyl group may be linear, branched or cyclic, and preferably a linear or branched alkyl group.

The alkyl group represented by R¹ of Formula (2) may be additionally substituted. The substituent is preferably a polyvinyl group, a polypropylene group, a polystyrene group, a fluorine atom, a chlorine atom, a sulfo group, a phosphonic group, a carboxy group, an alkoxycarbonyl group or an amino or ammonium group which may be substituted, more preferably a polyvinyl group, a polypropylene group, a polystyrene group, a fluorine atom, a sulfo group, a phosphonic group, a carboxy group, an alkoxycarbonyl group, an amino group or an ammonium group, and still more preferably a sulfo group, a phosphonic group or a carboxy group.

In a polyvinyl group, a polypropylene group and a polystyrene group as the substituent, the number of repeating units is preferably from 10 to 100,000, more preferably from 10 to 10,000, and still more preferably, from the viewpoint of viscosity, is from 10 to 5,000.

The aryl group represented by R¹ of Formula (2) is preferably an aryl group having 6 to 60 carbon atoms, more preferably an aryl group having 6 to 30 carbon atoms, still more preferably a phenyl group or a naphthyl group, and still more preferably a phenyl group.

The aryl group represented by R¹ of Formula (2) may be additionally substituted. The substituent is preferably an alkyl group, a halogen atom, a sulfo group or a salt thereof, a phosphonic group, a carboxy group, a halogen atom, a hydroxy group, a heteroaryl group or an amino group which may be substituted, more preferably an alkyl group, a halogen atom, a sulfo group or a salt thereof, a phosphonic group, a carboxy group, a halogen atom or a hydroxy group, and still more preferably an alkyl group, a carboxy group or a hydroxy group. The alkyl group as a substituent of the aryl-group represented by R¹ preferably has 1 to 60 carbon atoms, more preferably 1 to 40 carbon atoms, and still more preferably 1 to 30 carbon atoms.

When the R¹ is a phenyl group, the number of substituent(s) thereof is preferably 0 to 5, and more preferably 0 to 4. When R¹ is a phenyl group, while the substituted position(s) of the substituent(s) is not particularly restricted, it is preferably a meta-position or a para-position relative to the carbonyl group of Formula (2).

The heteroaryl group represented by R¹ of Formula (2) has the same definition and the same preferable scope as those of the heteroaryl group represented by R¹ of Formula (1).

The alkoxyl group represented by R¹ of Formula (2) is preferably 1 to 60 carbon atoms, more preferably 1 to 50 carbon atoms, and still more preferably 1 to 40 carbon atoms. The alkoxyl group represented by R¹ of Formula (2) may be additionally substituted. Such substituents include a hydroxy group, a phosphonic group, a sulfo group and a carboxy group.

The aryloxy group represented by R¹ of Formula (2) is preferably an aryloxy group having 6 to 60 carbon atoms, more preferably an aryloxy group having 6 to 50 carbon atoms, and still more preferably a phenyloxy group and a naphthyloxy group. The aryloxy group represented by R¹ of Formula (2) may be additionally substituted. The substituent is preferably a sulfo group, a phosphonic group, a carboxy group or salt thereof, an amino group which may be substituted, an alkyl group, a hydroxy group, an aryl group or a heteroaryl group, and more preferably a sulfo group, a phosphonic group, a carboxy group, an amino group, an ammonium group, a hydroxy group or an alkyl group.

The R² in Formula (2) is preferably a hydrogen atom, an alkyl group, an aryl group or a heteroaryl group, more preferably a hydrogen atom, an alkyl group or an aryl group, and still more preferably a hydrogen atom, an alkyl group or a phenyl group.

The alkyl group represented by R² of Formula (2) is preferably an alkyl group having 1 to 60 carbon atoms, more preferably an alkyl group having 1 to 50 carbon atoms, and still more preferably an alkyl group having 1 to 40 carbon atoms. The alkyl group represented by R² of Formula (2) may be additionally substituted. Such substituents include a hydroxy group, a phosphonic group, a sulfo group and a carboxy group.

The aryl group represented by R² of Formula (2) is preferably an aryl group having 6 to 60 carbon atoms, more preferably an aryl group having 6 to 50 carbon atoms, and still more preferably a phenyl group or a naphthyl group. The aryl group represented by R² of Formula (2) may be additionally substituted. The substituent is preferably a sulfo group, a phosphonic group, a carboxy group or salt thereof, an amino group which may be substituted, an alkyl group, a hydroxy group, an aryl group or a heteroaryl group, and more preferably a sulfo group, a phosphonic group, a carboxy group, an amino group, an ammonium group, a hydroxy group or an alkyl group. The alkyl group as a substituent of the aryl group represented by R² preferably has 1 to 60 carbon atoms, more preferably 1 to 50 carbon atoms, and still more preferably 1 to 40 carbon atoms.

When the R² of Formula (2) is a phenyl group, the number of substituent(s) thereof is preferably 0 to 4, and more preferably 0 to 3. When R² of Formula (2) is a phenyl group, the substituted position(s) of the substituent(s) is not particularly restricted, and preferably a meta-position or a para-position relative to the carbonyl group of Formula (2).

The heteroaryl group represented by R² of Formula (2) has the same definition and the same preferable scope as those of the heteroaryl group represented by R² of Formula (1).

### —Hydroxyamine Compound—

A compound represented by the following Formula (3) is preferred as the hydroxyamine compound.

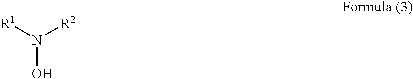

In Formula (3), R¹ and R² each independently represent a hydrogen atom, an alkyl group, an aryl group, a heteroaryl group, an alkoxy group or an aryloxy group, preferably a hydrogen atom, an alkyl group or an aryl group, and more preferably a hydrogen atom, an alkyl group or a phenyl group.

The alkyl group represented by R¹ or R² of Formula (3) is preferably an alkyl group having 1 to 60 carbon atoms, more preferably an alkyl group having 1 to 50 carbon atoms, and still more preferably an alkyl group having 1 to 40 carbon atoms. R¹ and R² may be linked together to form a ring.

The alkyl group represented by R¹ or R² of Formula (3) may be additionally substituted. The substituent is preferably a hydroxy group, a sulfo group, a phosphonic group, a carboxy group, a polyvinyl group, a polypropylene group or a polystyrene group, more preferably a hydroxy group, a sulfo group, a phosphonic group, a carboxy group, an amino group, ammonium, a polyvinyl group, a polypropylene group or a polystyrene group, and still more preferably a hydroxy group, a sulfo group, a phosphonic group or a carboxy group. In a polyvinyl group, a polypropylene group and a polystyrene group as the substituent, the number of repeating units is preferably from 10 to 100,000, more preferably from 10 to 10,000, and still more preferably, from the viewpoint of viscosity, is from 10 to 5,000.

The aryl group represented by R¹ or R² of Formula (3) is preferably an aryl group having 6 to 60 carbon atoms, more preferably an aryl group having 6 to 50 carbon atoms, and still more preferably a phenyl group or a naphthyl group.

The aryl group represented by R¹ or R² of Formula (3) may be additionally substituted. The substituent is preferably a sulfo group, a phosphonic group, a carboxy group, an alkyl group, an aryl group, a hydroxy group, or an amino group which may be substituted, more preferably a sulfo group, a phosphonic group, a carboxy group, an alkyl group or a hydroxy group, still more preferably a sulfo group, a carboxy group or a hydroxy group. The alkyl group as a substituent of the aryl group represented by R² preferably has 1 to 60 carbon atoms, more preferably 1 to 50 carbon atoms, and still more preferably 1 to 40 carbon atoms.

When the R¹ is a phenyl group, the number of substituent(s) thereof is preferably 0 to 5, and more preferably 0 to 4. When R¹ or R² is a phenyl group, the substituted position(s) of the substituent(s) is not particularly restricted, and preferably a para-position relative to the nitrogen atom of Formula (3).

The heteroaryl group represented by R¹ or R² of Formula (3) has the same definition and the same preferable scope as those of the heteroaryl group represented by R² of Formula (1).

The alkoxyl group represented by R¹ or R² of Formula (3) is preferably 1 to 60, more preferably 1 to 50 carbon atoms, and still more preferably 1 to 40 carbon atoms. The alkoxyl group represented by R² of Formula (2) may be additionally substituted. The substituent includes a hydroxy group, a phosphonic group, a sulfo group or a carboxy group.

The aryloxy group represented by R¹ or R² of Formula (3) is preferably an aryloxy group having 6 to 60 carbon atoms, more preferably an aryloxy group having 6 to 50 carbon atoms, and still more preferably a phenyloxy group or a naphthyloxy group. The aryloxy group represented by R² of Formula (3) may be additionally substituted. The substituent is preferably a sulfo group, a phosphonic group, a carboxy group or salt thereof, an amino group which may be substituted, an alkyl group, a hydroxy group, an aryl group or a heteroaryl group, and more preferably a sulfo group, a phosphonic group, a carboxy group, an amino group, an ammonium group, a hydroxy group or an alkyl group.

R¹ and R² may be either the same or different, and preferably a compound in which R¹ is the same as R², from the viewpoint of availability.

Specific examples of the compound represented by Formula (1) to be used for the present invention are provided below, but the compound represented by Formula (1) of the present invention is not limited to the specific examples.

### Hydroxamic Acid Compounds

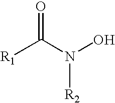

H-1 R₁═CH₃, R₂═H

H-2 R₁═C₂H₅, R₂═H

H-3 R₁═C₃H₇, R₂═H

H-4 R₁═C₄H₉, R₂═H

H-5 R₁═C₇H₁₅, R₂═H

H-6 R₁═C₉H₁₉, R₂═H

H-7 R₁═C₁₅H₃₁, R₂═H

H-8 R₁═CH₃, R₂═CH₃

H-9 R₁═C₇H₁₅, R₂═CH₃

H-10 R₁═C₉H₁₉, R₂═CH₃

H-11 R₁═C₁₅H₃₁, R₂═C₂H₅

H-12 R₁═CF₂CF₂CF₃, R₂═CH₃

H-13 R₁═(CH₂)₂CO₂CH₃, R₂═CH₃

H-14 R₁═CH₂N(CH₃)₂, R₂═CH₃

H-15 R₁═(CH₂)₃N⁺(CH₃)₃—Br⁻, R₂═CH₃

H-16 R₁═(CH₂)₃SO₃H, R₂═CH₃

H-17 R₁═(CH₂)₃COOH, R₂═CH₃

H-18 R₁═(CH₂)₃PO(OH)₂, R₂═CH₃

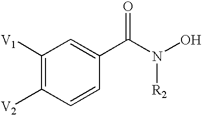

H-19 V₁═H, V₂═H, R₂═H

H-20 V₁═H, V₂═H, R₂═CH₃

H-21 V₁═H, V₂═H, R₂=Ph

H-22 V₁═C₁, V₂═H, R₂═CH₃

H-23 V₁═CH₃, V₂═H, R₂═H

H-24 V₁═H, V₂═OH, R₂═C₂H₅

H-25 V₁═SO₃H, V₂═H, R₂═CH₃

H-26 V₁═SO₃Na, V₂═H, R₂═CH₃

H-27 V₁═COOH, V₂═H, R₂═CH₃

H-28 V₁═PO(OH)₂, V₂═H, R₂═CH₃

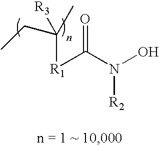

H-29 R₁═(CH₂)₄, R₂═H, R₃═H

H-30 R₁═(CH₂)₄, R₂═CH₃, R₃═H

H-31 R₁═(CH₂)₆, R₂═CH₃, R₃═CH₃

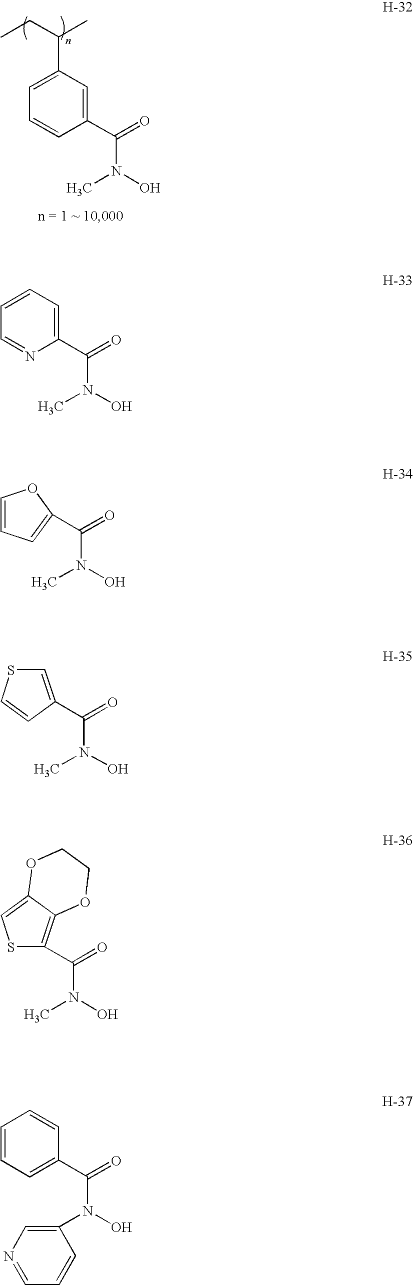

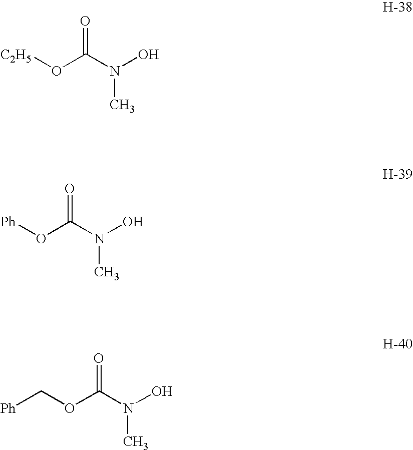

### Hydroxyamine Compounds

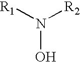

A-1 R₁═R₂═CH₃

A-2 R₁═R₂═H

A-3 R₁=Ph, R₂═Ph

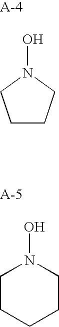

A-6 R₁═R₂═C₂H₅

A-7 R₁═R₂═C₇H₁₅

A-8 R₁═R₂═(CH₂)₆SO₃H

A-9 R₁═R₂═(CH₂)₆OH

A-10 R₁═R₂═(CH₂)₄COOH

A-11 R₁═R₂═(CH₂)₄PO(OH)₂

A-12 R₁═C₆H₁₃, R₂═C₂H₅

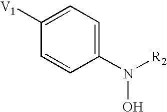

A-13 V₁═H, R₂═CH₃

A-14 V₁═CH₃, R₂═CH₃

A-15 V₁═OH, R₂=Ph

A-16 V₁═SO₃H, R₂═C₆H₄-4-SO₃H

A-17 V₁═COOH, R₂═H

A-18 V₁═PO(OH)₂, R₂═C₂H₅

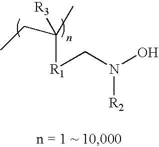

A-19 R₁═(CH₂)₄, R₂═CH₃, R₃═H

A-20 R₁═(CH₂)₄, R₂═CH₃, R₃═CH₃

A-21 R₁═(CH₂)₆, R₂—C₆H₅, R₃═CH₃

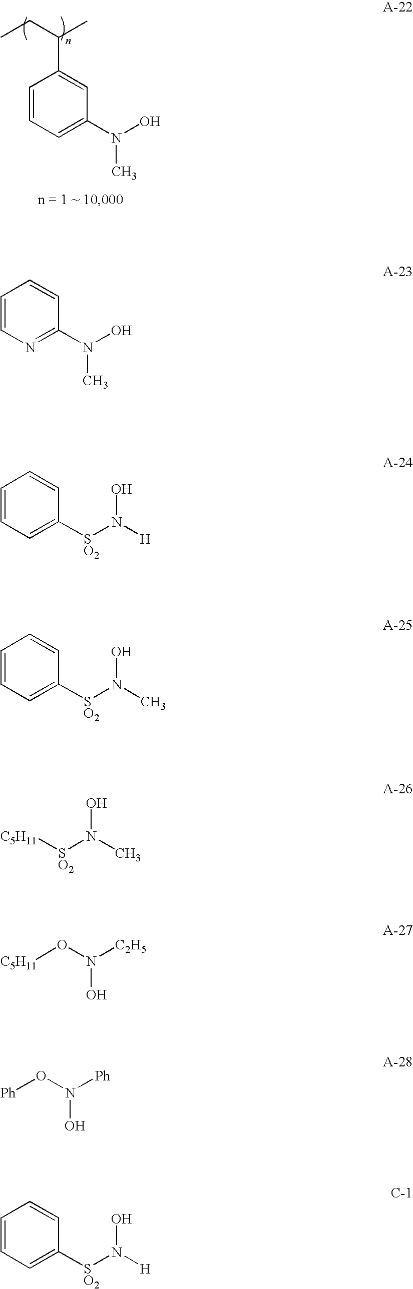

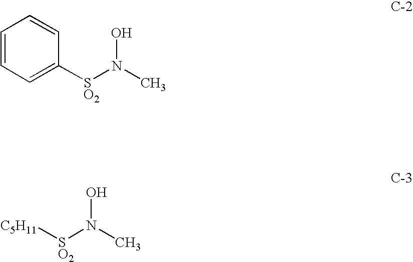

The compound represented by Formula (1) may be synthesized by conventional methods. Specifically, a method in which the synthesis is accomplished by causing hydroxylamine to react with a carboxylic acid halide or a carboxylic acid ester. Some of the compound represented by Formula (1) are compounds commercially available, examples of which include acetohydroxamic acid (manufactured by Tokyo Chemical Industry Co., Ltd.), N-methylfurohydroxamic acid (manufactured by Tokyo Chemical Industry Co., Ltd.), benzohydroxamic acid (manufactured by Tokyo Chemical Industry Co., Ltd.) and octanohydroxamic acid (manufactured by Tokyo Chemical Industry Co., Ltd.). The ratio of the compound represented by Formula (1) of the present invention to an electro-conductive polymer may be any value. From the viewpoint of achieving both a high electrical conductivity and a high durability, the weight ratio of the compound represented by Formula (1) to the electro-conductive polymer (compound represented by Formula (1): electro-conductive polymer) is preferably within a range of from 0.00001:1.0 to 1000:1, more preferably within a range of from 0.0001:1.0 to 500:1, and still more preferably within a range of from 0.0005:1.0 to 100:1.

The compound represented by Formula (1) of the present invention may be added by any method. Preferred is a method that is mixing a dispersion liquid containing the electro-conductive polymer and a solution dissolving the compound represented by Formula (1). Details will be described below.

### (Other Additives)

### —Dopant—

From the viewpoint that the dispersibility of the electro-conductive polymer in a solvent is improved, it is preferable that the electro-conductive composition contain at least one dopant. The electro-conductive polymer layer is suitably formed by coating as described below. To obtain a dispersion liquid (composition) with favorable dispersibility is important from the viewpoint of production. The dopant as used herein means an additive which has an action of changing the electrical conductivity of an electro-conductive polymer. Such dopants include electron-accepting (i.e., acceptor) dopants and electron-donating (i.e., donor) dopants.

Examples of electron-accepting (i.e., acceptor) dopants include halogens (Cl₂, Br₂, I₂, ICl, ICl₃, IBr, IF), Lewis acids (PF₅, AsF₅, SbF₅, BF₃, BCl₃, BBr₃, SO₃), proton acids (HF, HCl, HNO₃, H₂SO₄, HClO₄, FSO₃H, CISO₃H, CF₃SO₃H, various organic acids, amino acids, and the like), transition metal compounds (FeCl₃, FeOCl, TiCl₄, ZrCl₄, HfCl₄, NbF₅, NbCl₅, TaCl₅, MoF₅, MoCl₅, WF₆, WCl₆, UF₆, LnCl₃ (Ln is lanthanide, such as La, Ce, Pr, Nd, and Sm), electrolyte anions (Cl⁻, Br⁻, I⁻, ClO₄⁻, PF₆—, AsF₆—, SbF₆—, BF₄—, various sulfonate anions), O₂, XeOF₄ (NO₂⁺)(SbF₆⁻), (NO₂⁺)(SbCl₆⁻), (NO₂⁺)(BF₄⁻), FSO₂OOSO₂F, AgClO₄, H₂IrCl₆ and La(NO₃)₃.6H₂O.

Examples of electron-donating (i.e., donor) dopants include alkali metals (Li, Na, K, Rb, Cs), alkaline earth metals (Ca, Sr, Ba), lanthanides (Eu, or the like), and others (R₄N⁺, R₄P⁺, R₄As⁺, R₃S⁺, acetylcholine).

Examples of the combination of the dopant and the electro-conductive polymer include:

(A) polyacethylene with I₂, AsF₅, FeCl₃ or the like;
(B) poly(p-phenylene) with AsF₅, K, AsF₆⁻ or the like;
(C) polypyrrole with ClO₄⁻ or the like;
(D) polythiophene with ClO₄⁻, or a sulfonic acid compound, especially polystyrene sulfonic acid, a nitrosonium salt, an aminium salt, a quinone, or the like;
(E) polyisothianaphthene with I₂ or the like;
(F) poly(p-phenylene sulfide) with AsF₅;
(G) poly(p-phenyleneoxide) with AsF₅;
(H) polyaniline with HCl or the like;
(I) poly(p-phenylenevinylene) with H₂SO₄ or the like;
(J) polythiophenylenevinylene with I₂ or the like;
(K) nickel phthalocyanine with I₂.

Among these combinations, preferred is the combination (D) or (H), more preferred, from the viewpoint that the dope condition is high in stability, is the combination of polythiophenes (polythiophene and its derivative) with a sulfone compound, and still more preferred, from the viewpoint that the aqueous dispersion liquid may be prepared and an electro-conductive thin film may be prepared easily by coating, is the combination of a polythiophene with a polystyrene sulfonic acid.

The ratio of the electro-conductive polymer to the dopant may be any value. From the viewpoint of well achieving both the stability of the dope condition and the electrical conductivity, the weight ratio of the electro-conductive polymer to the dopant (electro-conductive polymer: the dopant) is preferably within a range of from 1.0:0.0000001 to 1.0:10, more preferably within a range of from 1.0:0.00001 to 1.0:1.0, and still more preferably within a range of 1.0:0.0001 to 1.0:0.5.

In order to improve the dispersibility of an electro-conductive polymer, an ion-conductive polymer in which polymer chain has been doped with an electrolyte may be used. Examples of such a polymer chain include polyethers (polyethylene oxide, polypropylene oxide, and the like), polyesters (polyethylene succinate, poly-β-propiolactone, and the like), polyamines (polyethyleneimine, and the like), and polysulfides (polyalkylene sulfide, and the like). The electrolyte doped may be various alkali metal salts.

Examples of the alkali metal ion which constitutes the alkali metal salt include Li⁺, Na⁺, K⁺, Rb⁺ and Cs⁺. Examples of the anion which forms the counter salt include F⁻, Cl⁻, Br⁻, I⁻, NO₃⁻, SCN⁻, ClO₄⁻, CF₃SO₃⁻, BF₄⁻, AsF₆⁻ and BPh₄⁻.

Examples of the combination of the polymer chain and the alkali metal salt include polyethylene oxide with LiCF₃SO₃, LiClO₄ or the like, polyethylene succinate with LiClO₄, LiBF₄, poly-α-propiolactone, LiClO₄ or the like, polyethyleneimine with NaCF₃SO₃, LiBF₄ or the like, and polyalkylene sulfide with AgNO₃ or the like.

### —Other Additives—

It is also possible to additionally add a solvent, described below, and other additives to the electro-conductive composition of the present invention. The available additives include UV absorbers, inorganic fine particles and polymer particles for the purpose of increasing the film strength, silane coupling agents, and fluorine-containing compounds (especially, fluorine-containing surfactants) for the purpose of reducing a refractive index and increasing transparency simultaneously.

### <Electrode Material>

The electrode material of the present invention has a layer made of the above-described electro-conductive polymer composition, which layer is hereinafter suitably referred to as an “electro-conductive polymer layer”, on a support. In addition, a protective layer or an intermediate layer may be additionally provided.

### (1) Support

Any material which is in the form of a stable panel and which satisfies required flexibility, strength, durability may be used as the support capable of being used in the present invention. In the event that the resulting electro-conductive polymer material is used in an image display device, a solar cell, or the like, a high transparency is required and therefore the use of a transparent substrate with a smooth surface is preferred.

In the present invention, examples of the material of the support include glass, transparent ceramics, metal and plastic film. Glass and transparent ceramics are inferior in plasticity to metal and plastic film. Plastic film is less expensive than metal and has plasticity. Therefore, plastic film is preferred as the support of the present invention. Examples thereof include films using resin such as cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinyl acetal and polyarylate. In particular, polyester-based resins (hereinafter, suitably referred to as “polyesters”) are preferred. As the polyesters, preferred are linear saturated polyesters which are synthesized from an aromatic dibasic acid or its ester-forming derivative with a diol or its ester-forming derivative.

Specific examples of the polyester which may be used for the present invention include polyethylene terephthalate, polyethylene isophthalate, polyethylene naphthalate, polybutylene terephthalate, poly(1,4-cyclohexylenedimethylene terephthalate) and polyethylene 2,6-phthalene dicarboxylate. Among these, polyethylene terephthalate, polyethylene naphthalate are preferred from the viewpoint of easy availability, economical efficiency and effect.

Moreover, a mixture of these copolymers or a mixture of these polymers and other resins in a small proportion may also be used as the material of a film, unless the effect of the present invention is impaired.

Furthermore, for the purpose of improving a smoothness, it is permissible to cause the polyester film to contain a small amount of inorganic or organic particles, for example, inorganic fillers, such as titanium oxide, calcium carbonate, silica, barium sulfate and silicone, organic fillers, such as acryls, benzoguanamine, Teflon (registered trademark) and epoxy resin. Adhesive improvers or antistatic agents, such as polyethylene glycol (PEG) and sodium dodecylbenzene sulfonate may be included into the polyester film.

The polyester film to be used for the present invention may be produced by forming a polyester resin like that mentioned above into a film shape by melt extrusion; and then subjecting the resultant to oriented crystallization by longitudinal and transverse biaxial stretching and crystallization by heat treatment. As the method and condition regarding the production of such films, conventional methods and conditions may be selected appropriately and used.

The thickness of the support may be selected appropriately, and it generally is within a range of from 5 μm to 500 μm.

In the present invention, an easy adhesion layer may be formed on the support for the purpose of improving the adhesiveness of the electro-conductive polymer layer. The easy adhesion layer preferably has a structure containing a styrene-butadiene copolymer (hereinafter, suitably referred to as “SBR”) or a water-base urethane resin and a crosslinking agent. The SBR means a copolymer which is composed mainly of styrene and butadiene and in which other component(s) is copolymerized according to the need. This type of copolymer is known that copolymers with various physical properties may be obtained by adjusting the contained proportions of styrene and butadiene.

In the event that an easy adhesion layer is formed in the present invention, the styrene-butadiene copolymer is preferably in the form of latex. Specifically, commercially available products which are supplied from Nippon Zeon Co., Ltd. under the trade name of NIPOL, from Sumitomo Naugatuck Co., Ltd. under the trade name of NAUGATEX, from Takeda Chemical Industries, Ltd. under the trade name of CROSLENE, from Asahi-Dow Ltd. under the trade name of ASAHI DOW LATEX, and from Dainippon Ink & Chemicals, Inc. and overseas manufacturers may also be used.

The particle diameter of the dispersed particles of the latex is preferably 5 μm or less, more preferably 1 μm or less, and still more preferably 0.2 μm or less. If the particle diameter is excessively large, problems will occur such as that particle aggregation tends to occur during the coating step or the obtained films will become poor in transparency, gloss, or the like. Furthermore, if thin coated layers are required, it is necessary to make the particle diameter small correspondingly.

The content ratio of styrene/butadiene in the styrene-butadiene copolymer of the easy adhesion layer is preferably from about 50/50 to about 80/20. The proportion of the SBR contained in the latex is preferably from 30% to 50% by weight in terms of solid weight.

A cross-linking agent is added to the easy adhesion layer for the purpose of improving the properties of the SBR, and the cross-linking agent to be used is preferably a triazine-based cross-linking agent.

### (2) Electro-Conductive Polymer Layer

The thickness of the electro-conductive polymer layer is not particularly limited, and it is preferably within a range of from 1 nm to 2 μm, and more preferably within a range of from 10 nm to 1 μm. When the thickness of the electro-conductive polymer layer is within such a range, a sufficient electrical conductivity and a sufficient transparency may be attained.

From the viewpoint of convenience that an electrode material having a large area may be produced at one time, it is preferable to form the electro-conductive polymer layer by coating. Methods other than coating include spin coating, transfer. The coating liquid may be an aqueous dispersion liquid or an organic solution.

The coating liquid to be used for forming an electro-conductive polymer layer (hereinafter referred to as an “electro-conductive polymer layer coating liquid”) contains at least the aforesaid electro-conductive polymer and the compound represented by Formula (1), and a solvent for coating, the aforesaid dopant or the like is added appropriately depending on the situation. In addition, the above-mentioned additives may also be added.

As the solvent of the electro-conductive polymer layer coating liquid, water, alcohols, ethers, ketones, esters, hydrocarbons, halogenated hydrocarbons, amides, or the like may be used. From the viewpoint of cost, water and lower alcohols are preferable. Considering the environment, the use of water is preferred.

In the event that water is used as a solvent, conventional methods may be used as the method for dispersing the electro-conductive polymer. Examples are dispersing methods such as the jaw crusher method, the ultracentrifugal pulverization method, the cutting mill method, the automatic mortar method, the disc mill method, the ball mill method, and the ultrasonic dispersion method.

The concentration of the electro-conductive polymer in the electro-conductive polymer layer coating liquid is appropriately adjusted from the viewpoint of viscosity or the like, and it generally is preferably from 0.01% by mass to 50% by mass, and more preferably from 0.1% by mass to 10% by mass.

On the other hand, it is preferable to prepare a solution in which the compound represented by Formula (1) has been dissolved in advance, and then mix this solution with a dispersion liquid in which the electro-conductive polymer has been dispersed to prepare a coating liquid. As the solvent for dissolving the compound represented by Formula (1), water, alcohols, ethers, ketones, esters, hydrocarbons, halogenated hydrocarbons, amides, or the like may be used, and specifically methyl ethyl ketone, methanol, water may be used. From the viewpoint of solubility and cost, methyl ethyl ketone is preferred.

The concentration of the compound represented by Formula (1) in the solution containing the compound represented by Formula (1) is appropriately adjusted from the viewpoint of electrical conductivity, transparency, durability, or the like, and it is preferably 0.00001% by mass to 100% by mass, and more preferably 0.0001% by mass to 50% by mass.

At the time of mixing the dispersion liquid in which the electro-conductive polymer is dispersed and the solution in which the compound represented by Formula (1) is dissolved, it is preferable to produce a uniform state.

By applying the resulting electro-conductive polymer layer coating liquid, an electro-conductive polymer layer is formed. Conventional application methods, for example, methods using an extrusion die coater, an air doctor coater, a blade coater, a rod coater, a knife coater, a squeeze coater, a reverse roll coater, a bar coater or the like, may be used as the applying method.

In the event that two or more layers such as electro-conductive polymer layers are formed on a support, application and drying may be done layer by layer, or alternatively two or more layers may be formed by simultaneous multilayer application. The simultaneous multilayer application is preferable from the viewpoint of saving of production cost and shortening of production time. The “simultaneous multilayer application” as used herein means applying two coating liquids in a state that the liquids are in contact. The simultaneous multilayer application may be carried out by using a curtain coater, a slide coater, an extrusion coater, or the like. Among these, a curtain coater is preferred.

### <Applications>

The electro-conductive composition of the present invention will develop no aggregation of an electro-conductive polymer. Moreover, it may form an electro-conductive film excellent in photo-durability, transparency and electrical conductivity. This electro-conductive film may be used suitably as wires, electrodes (substrate electrodes, or the like) of electronic materials. Particularly because the electro-conductive film may be formed by coating, an electrode material having a large area may be produced therefrom easily, and the electro-conductive film is suited for the application to substrate electrodes.

Such electro-conductive films may be used suitably for flexible electroluminescence devices (OLED), touch screens, touch panels, organic TFTs, actuators, sensors, electronic papers, flexible light modulators, solar cell, or the like.

### EXAMPLES

The present invention is illustrated below more concretely with reference to Examples. The materials, the reagents, the amounts of substances and their proportions, the operations shown in the following Examples may be appropriately varied unless they deviate from the purpose of the present invention. Therefore, the scope of the present invention is not limited to the following Examples.

### Example 1

A coating liquid-1 was obtained by adding, to an aqueous dispersion liquid of poly(3,4-ethylenedioxy)thiophene (PEDOT)/polystyrene sulfonate (PSS) (Denatron P502 manufactured by Nagase Chemical Co., Ltd.), methyl ethyl ketone solution of 1% by mass of Specific Example Compound H-4 in the same weight as that of the PEDOT, followed by mixing.

This coating liquid-1 was applied to a PET film by the use of a No. 9 bar coater and was dried, to obtain Sample-1. The obtained layer was 200 nm in thickness. Sample-1 was evaluated by the following method.

### <Measurement of Transmittance>

Transmittance was measured with a UV/vis spectrum meter (Shimadzu U2400). The Sample-1 immediately after its preparation was measured at four points, and the average of the measurements was used as a measured value. The results are shown in Table 1.

### <Measurement of Surface Resistivity>

Surface resistivity was measured with a LORESTA resistance meter (manufactured by Mitsubishi Chemical Corporation). The Sample-1 immediately after its preparation was measured at four points, and the average of the measurements was used as a measured value. The results are shown in Table 1.

### <Evaluation of Photo-Durability>

Sample-1 was irradiated for 80 hours with light from a xenon lamp light source (150,000 lux) through a UV cut-off filter (capable of absorbing 370 nm light at a rate of 90%), and the transmittance and the surface resistivity after the irradiation were measured by the methods described above. The results are shown in Table 1.

### <Measurement of Haze>

The haze of Sample-1 immediately after being produced was measured by using a haze meter MODEL 1001DP manufactured by NIPPON DENSHOKU KOGYO Co., Ltd. The results are shown in Table 1.

### Examples 2 to 6

Samples 2 to 6 were prepared in the same manner as in Example 1 except for adding the compounds shown in Table 1 instead of Specific Example Compound H-4. The compounds shown in Table 1 were each added so that the weight thereof become equal to that of the Compound H-4 added in Example 1. The Samples 2 to 6 were evaluated in the same manner as in Example 1. The results are shown in Table 1.

### Example 7

Sample-7 was prepared in the same manner as in Example 1 except for using a glass substrate instead of the PET substrate. The Sample-7 was evaluated in the same manner as in Example 1. The results are shown in Table 1.

### Comparative Example 1

Comparative Sample-1 was prepared in the same manner as in Example 1 except for failing to add Specific Example Compound H-4. The Comparative Sample-1 was evaluated in the same manner as in Example 1. The results are shown in Table 1.

### Comparative Example 2

A coating liquid was prepared in the same manner as Example-1 except for changing the Specific Example Compound H-4 to an aqueous solution including polyphosphoric acid (manufactured by Tokyo Chemical Industry Co., Ltd.) at 10% by mass. Comparative Sample-2 was prepared by using this coating liquid in the same method as that of Example 1. The Comparative Sample-2 was evaluated in the same manner as in Example 1. The results are shown in Table 1.

### Comparative Example 3

Comparative Sample-3 was prepared in the same manner as in Example 1 except for changing Specific Example Compound H-4 to the Compound 1 provided below. The Compound 1 was added so that the weight thereof become equal to that of the Compound H-4 added in Example 1. The Comparative Sample-3 was evaluated in the same manner as in Example 1. The results are shown in Table 1.

TABLE 1

| | | Before | | After | | | |
|---|---|---|---|---|---|---|---|
| | | light | | light | | | |
| | | irradiation | | irradiation | | Haze | |
| | | Surface | | Surface | | before | |
| Sample | | resistivity | Transmittance | resistivity | Transmittance | light | |
| No. | Additive | (Ω/□) | (%) | (Ω/□) | (%) | irradiation | Remarks |
| Example 1 | H-4 | 12,000 | 83 | 19,000 | 82 | 2.0% or less | |
| Example 2 | H-5 | 11,500 | 83 | 16,500 | 82 | 2.0% or less | |
| Example 3 | H-14 | 16,000 | 83 | 17,000 | 82 | 2.0% or less | |
| Example 4 | H-19 | 11,500 | 83 | 20,000 | 82 | 2.0% or less | |
| Example 5 | A-7 | 12,500 | 83 | 24,000 | 82 | 2.0% or less | |
| Example 6 | A-13 | 12,500 | 83 | 26,000 | 82 | 2.0% or less | |
| Example 7 | H-4 | 12,000 | 83 | 19,000 | 82 | 2.0% or less | Glass substrate |
| Comparative | None | 11,500 | 83 | 48,000 | 82 | 2.0% or less | |
| example 1 | | | | | | | |
| Comparative | Polyphosphoric | 152,000 | 70 | 550,000 | 62 | 13% | |
| example 2 | acid | | | | | | |
| Comparative | Compound 1 | 18,000 | 78 | 44,000 | 75 | 9% | |
| example 3 | | | | | | | |

Compound 1

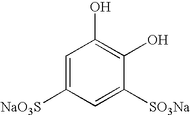

As shown by the results in Table 1, the electro-conductive films formed from the electro-conductive polymer compositions of Examples 1 to 7 exhibited high transmittances and low surface reisistivities before the irradiation with light. Moreover, high transmittances and low surface resistivities were maintained also after the irradiation with light and, therefore, the electro-conductive films were excellent in photo-durability.

On the other hand, in Comparative Example 1, the transmittance was equivalent to those of Examples 1 to 7, but the surface resistivity increased remarkably after the irradiation with light in comparison to Examples 1 to 7.

Moreover, in each of Comparative Examples 2 and 3, aggregation of a polymer occurred in the coating liquid and, as a result, no uniform coating liquid was obtained and the coating liquid became opaque. It is thought that this caused the decrease in transmittance and increase in surface resistivity after the irradiation with light.

### Examples 8 to 10

Samples 8 to 10 were prepared in the same manner as in Example 1 except for using the following aqueous dispersion liquids, respectively, instead of the Denatron P502 (manufactured by Nagase Chemical Co., Ltd.) used in Example 1.

### Example 8

Aqueous dispersion liquid of poly(3,4-ethylenedioxy)thiophene/polystyrene sulfonic acid (Baytron P manufactured by H.C. Starck GmbH)

### Example 9

Aqueous dispersion liquid of poly(3,4-ethylenedioxy)thiophene/polystyrene sulfonic acid (Baytron P-HC V4 manufactured by H.C. Starck GmbH)

### Example 10

Aqueous dispersion liquid of poly(3,4-ethylenedioxy)thiophene/polystyrene sulfonic acid (Baytron P-AG manufactured by H.C. Starck GmbH)

The Samples 8 to 10 were evaluated in the same manner as in Example 1. The results are shown in Table 2.

TABLE 2

| | | Before light irradiation | | After light irradiation | | |
|---|---|---|---|---|---|---|
| | | Surface | | Surface | | |
| | | resistivity | Transmittance | resistivity | Transmittance | |
| Sample No. | Additive | (Ω/□) | (%) | (Ω/□) | (%) | Haze |
| Example 8 | H-4 | 4,200 | 83 | 6,000 | 82 | 2.0% or less |
| Example 9 | H-4 | 1,500 | 83 | 1,900 | 82 | 2.0% or less |
| Example 10 | H-4 | 3,000 | 83 | 4,000 | 82 | 2.0% or less |

As shown in Table 2, even though the electro-conductive polymer was changed in kind, a high transmittance and a low surface resistivity were exhibited and the photo-durability was also excellent.

### Examples 11 and 12

While in Example 1, PEDOT/PSS and Specific Example Compound H-4 were added so that they become equal in weight, Samples 11 and 12 were prepared in the same manner as in Example 1 except for changing the ratio (weight ratio) as shown in Table 3. The Samples 11 and 12 were evaluated in the same manner as in Example 1. The results are shown in Table 3.

TABLE 3

| | | | Before light irradiation | | After light irradiation | | |
|---|---|---|---|---|---|---|---|
| | | | Surface | | Surface | | |
| | | Added ratio (by mass) | Resistivity | Transmittance | Resistivity | Transmittance | |
| Sample No. | Additive | Additive:PEDOT/PSS | (Ω/□) | (%) | (Ω/□) | (%) | Haze |
| Example 11 | H-4 | 1:10 | 11,000 | 83 | 18,000 | 82 | 2% or less |
| Example 12 | H-4 | 1:100 | 10,000 | 83 | 17,500 | 82 | 2% or less |

As shown in Table 3, even though the added ratio of the electro-conductive polymer to the compound represented by Formula (1) was changed, a high transmittance and a low surface resistivity were exhibited and the photo-durability was also excellent.

### Example 13

Sample-13 was prepared in the same manner as in Example 1, except for using a dispersion liquid containing 3.0% by mass of polyaniline (manufactured by Aldrich Chemical Company, Inc.) in xylene instead of Denatron P502 (manufactured by Nagase Chemical Co., Ltd.). The Sample-13 was evaluated in the same manner as in Example 1. The results are shown in Table 4.

### Comparative Example 4

Comparative Sample-4 was prepared in the same manner as in Example 13, except for failing to add Specific Example Compound H-4. The Comparative Sample-4 was evaluated in the same manner as in Example 1. The results are shown in Table 4.

TABLE 4

| | | | Before light irradiation | | After light irradiation | | |
|---|---|---|---|---|---|---|---|
| | | | Surface | | Surface | | |
| | | | Resistivity | Transmittance | Resistivity | Transmittance | |
| Sample No. | Additive | Polymer | (Ω/□) | (%) | (Ω/□) | (%) | Haze |
| Example 13 | H-4 | polyaniline | 1200 | 72 | 1800 | 70 | 4% |
| Comparative | None | polyaniline | 1400 | 72 | 3800 | 65 | 8% |
| example 4 | | | | | | | |

As shown in Table 4, Example 13, in which the electro-conductive polymer was changed in kind, exhibited a higher transmittance and a lower surface resistivity in comparison to Comparative Example 4 and it was also superior in photo-durability.

### Example 14

### Production of Touch-Panel Device

A coating liquid was obtained by adding, to an aqueous dispersion liquid of poly(3,4-ethylenedioxy)thiophene (PEDOT)/polystyrene sulfonate (PSS) (Denatron P502 manufactured by Nagase Chemical Co., Ltd.), ethylene glycol in the same weight as that of the PEDOT and methyl ethyl ketone solution containing 1% by mass of Specific Example Compound H-4 in the same weight as that of the PEDOT, followed by mixing. This coating liquid-1 was applied to a PET film by the use of a No. 9 bar coater, and was dried, to obtain Sample-14. This film had a surface resistivity of 1200 Ω/□, and a transmittance of 83%.

Next, a substrate composed provided indium tin oxide on a glass substrate by vapor deposition was prepared, and a dot spacer of 4 μm in thickness (RESIST CR-103C manufactured by Toyobo Co., Ltd.) was formed by photolithography. Then, a wire was formed by the screen printing of a silver paste (DW-250H-5 manufactured by Toyobo Co., Ltd.). Furthermore, an insulated portion was formed by the use of an insulating ink (trade name: JELCONIN, manufactured by Jujo Chemical Co., Ltd.). Finally, Sample-14, described above, was adhered thereto to prepare a touch-panel device.

### (Evaluation of Touch-Panel Device)

The touch-panel device was operated under the condition that the outdoor light entered and, as a result, it was found that the device exhibited excellent-touch-panel property. In other words, it was confirmed that the touch-panel device formed from the electro-conductive composition of the present invention had a high photo-durability.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An electro-conductive polymer composition comprising an electro-conductive polymer and a compound represented by the following Formula (1): 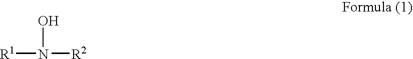
wherein in Formula (1), R¹ represents a hydrogen atom, an alkyl group, an acyl group, an aryl group, an alkoxy group, an aryloxy group or a heteroaryl group; and R² represents a hydrogen atom, an alkyl group, an aryl group, a heteroaryl group or a sulfonyl group.

2. The electro-conductive polymer composition according to claim 1, wherein the electro-conductive polymer includes a polythiophene or a derivative thereof.

3. The electro-conductive polymer composition according to claim 2, wherein the electro-conductive polymer includes poly(3,4-ethylenedioxy)thiophene.

4. The electro-conductive polymer composition according to claim 1, further comprising polystyrene sulfonic acid as a dopant.

5. The electro-conductive polymer composition according to claim 1, wherein the compound represented by Formula (1) comprises at least one compound selected from the group consisting of hydroxamic acid compounds and hydroxyamine compounds.

6. The electro-conductive polymer composition according to claim 5, wherein the hydroxamic acid compounds are compounds represented by the following Formula (2): 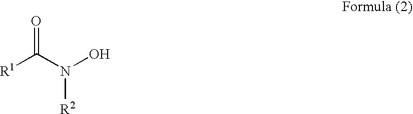
wherein in Formula (2), R¹ represents a hydrogen atom, an alkyl group, an aryl group, a heteroaryl group, an alkoxy group or an aryloxy group; and R² represents a hydrogen atom, an alkyl group, an aryl group or a heteroaryl group.

7. The electro-conductive polymer composition according to claim 5, wherein the hydroxyamine compounds are compounds represented by the following Formula (3): 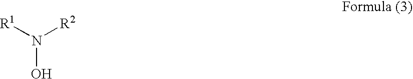
wherein in Formula (3), R¹ and R² each independently represent a hydrogen atom, an alkyl group, an aryl group, a heteroaryl group, an alkoxy group or an aryloxy group.

8. The electro-conductive polymer composition according to claim 1, further comprising water, wherein the form of the electro-conductive polymer composition is a dispersion liquid.

9. The electro-conductive polymer composition according to claim 1, wherein the content ratio of the compound represented by Formula (1) to the electro-conductive polymer (compound represented by Formula (1): electro-conductive polymer) is within the range of from 0.0005:1.0 to 100:1 by mass.

10. An electrode material having, on a support, a layer formed by applying the electro-conductive polymer composition according to claim 1.
